(19) United States
(12) Patent Application Publication
(10) Pub. No.: US 2013/0270473 A1
(43) Pub. Date: Oct. 17, 2013

(54) Valve for Controlling Fluids

(71) Applicant: Nicolas Houís, Bietigheim-Bissingen (DE)

(72) Inventor: Nicolas Houís, Bietigheim-Bissingen (DE)

(73) Assignee: Robert Bosch GmbH, Stuttgart (DE)

(21) Appl. No.: 13/820,699

(22) PCT Filed: Jul. 12, 2011
(86) PCT No.: PCT/EP2011/061858

§ 371 Date: Jun. 19, 2013

(30) Foreign Application Priority Data
Sep. 8, 2010 (DE) 10 2010 040 372.5

(51) Int. Cl. F16K 1/38

(52) U.S. Cl. CPC F16K 1/38
USPC 251/333

(57) ABSTRACT

A valve for controlling fluids with an improved flow behavior includes a valve element with a through opening and a valve seat, wherein the valve seat is formed on a first conical region of the valve element, and closing element opens and closes the through opening at the valve seat, wherein the through opening has a shape which widens in the flow direction.

### PRIOR ART

The present invention relates to a valve for controlling fluids, with an improved flow behavior, and to a braking device having a valve of this type.

Valves for controlling fluids are known in various embodiments from the prior art. In current applications of valves in braking devices of vehicles, 2/2-way valves are employed as hydraulic valves. In this case, a certain minimum throughflow has to be achieved in the case of a stipulated stroke and a stipulated differential pressure. The known valves have through orifices which are of cylindrical design. It was found, here, that flow breakaways may occur in the valve seat during operation when the valve is open. These flow breakaways lead to a marked reduction in the throughflow cross section which deviates significantly from the theoretical geometric cross section. However, because of this, the flow resistance rises when the valve is open, and therefore this leads to a reduction in the throughflow at the valve. However, the valves in braking devices of this type should have the smallest possible build and be as compact as possible in order to take up as little construction space as possible.

### DISCLOSURE OF THE INVENTION

By contrast, the valve according to the invention for controlling fluids, having the features of claim 1, has the advantage that, when the valve is open, an improved flow, particularly in regions upstream of the valve seat, is obtained. As a result, in comparison with previous valves, throughflow through the open valve can be increased in the case of a given differential pressure upstream and downstream of the valve and in the case of a given valve stroke. This is achieved, according to the invention, in that a through orifice has a shape which widens in the flow direction. In other words, a diameter on an inflow side of the through orifice is smaller than a diameter on an outflow side of the latter. What is achieved thereby is that, with the valve open, the flow at the outlet from the through orifice is deflected to a lesser extent. This gives rise to reduced breakaways in the valve region downstream of the valve seat, with the result that an actual throughflow cross section is enlarged in this region and the throughflow through the valve consequently rises.

The subclaims show preferred developments of the invention.

Preferably, the through orifice is formed in such a way that it widens conically in the flow direction. As a result, the through orifice can be produced in a simple way and has defined flow conditions.

Especially preferably, an angle of the conically widening through orifice to a parallel of a mid-axis of the valve is in a range of between 1° and 10° and preferably lies between 5° and 10° and is preferably approximately 7.5°.

Further preferably, an angle of a first conical region, at which the valve seat is formed, to the mid-axis is between 40° and 50° and especially preferably amounts to approximately 45°.

In order to achieve especially good flow conditions when the valve is open, a ratio between a minimum diameter of the through orifice and a maximum diameter of the through orifice is preferably in a range of between 0.73 and 0.83 and preferably in a range of between 0.77 and 0.79 and preferably amounts to 0.78.

To seal off the valve reliably, the closing element is preferably formed in such a way that it has a hemispherical shape in section. As a result, the valve has a seal-off between the conical region of the valve element and the spherical region of the closing element.

Further preferably, the valve element has on an inflow side, directly adjacently to the through orifice, a second conical region. Preferably, in this case, a transition from the second conical region into the through orifice is of rounded form.

Preferably, a ratio of a maximum stroke to the maximum diameter of the through orifice lies in a range of 0.1 to 0.3, preferably in a range of 0.14 to 0.28, and especially preferably amounts to approximately 0.21.

The invention relates, furthermore, to a braking device for vehicles, comprising a valve according to the invention for controlling a hydraulic fluid. The invention improves the response times particularly in modern brake safety systems, such as, for example, ESP systems.

### DRAWING

An exemplary embodiment of the invention is described in detail below, with reference to the accompanying drawing in which:

FIG. 1 shows a diagrammatic sectional view of a valve according to a preferred exemplary embodiment of the invention in the open state,

FIG. 2 shows a diagrammatic partial sectional view of the valve of FIG. 1 with an illustration of the valve throughflow, and

FIG. 3 shows a graph which illustrates throughflow against a valve stroke of the valve.

### PREFERRED EMBODIMENT OF THE INVENTION

A valve 1 for controlling fluids is described in detail below with reference to FIGS. 1 to 3. The valve 1 is employed in a brake safety system of a vehicle as a switching valve.

As is clear from FIG. 1, the valve 1 comprises a valve element 2 with a through orifice 4 and a valve seat 5 formed on the valve element 2. The valve seat 5 is formed on a first conical region 6 of the valve element. A closing element 3 has a hemispherical shape and seals off at the valve seat 5.

As is clear from FIG. 1, the through orifice 4 has a shape widening in a throughflow direction A of the valve 1. In this exemplary embodiment, the through orifice 4 widens conically. In this case, an angle β between a parallel to a mid-axis X-X and the through orifice is 7.5°. A minimum diameter D1 of the through orifice and a maximum diameter D2 of the through orifice are in this case selected in such a way that a ratio of the minimum diameter D1 to the maximum diameter D2 amounts to 0.78. Furthermore, a ratio of a maximum stroke H (fully open valve) to the diameter D2 of the through orifice is approximately 0.21.

As is also clear from FIG. 1, a second conical region 8 is formed on an inflow side, a transition between the second conical region 8 into the through orifice 4 being rounded.

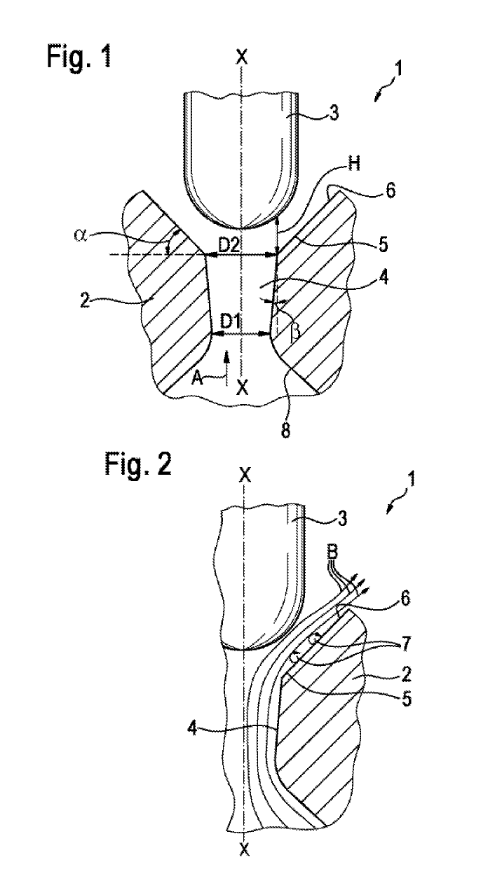

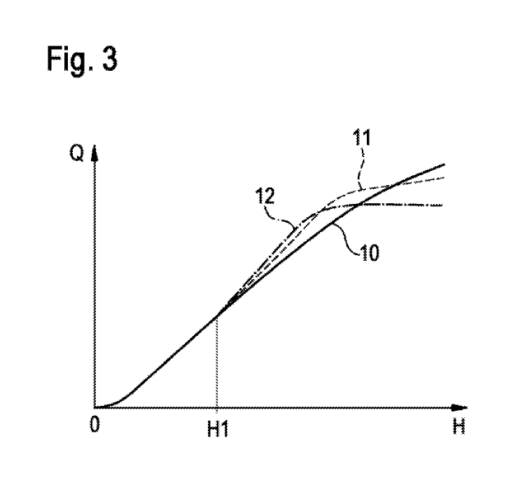

FIG. 2 shows the flow conditions when the valve 1 is open, the arrows B indicating the throughflow through the open valve. As is clear from FIG. 2, although breakaways 7 still occur at the first conical region 6 which reduce the actual flow cross section in the region between the first conical region 6 and the closing element 3, these breakaways are reduced significantly in comparison with a cylindrical through orifice. In FIG. 3, for example, three curves of the throughflow Q are plotted against the valve stroke H. The unbroken line 10 in this case shows the throughflow for a cylindrical through bore. The dashed line 11 shows the throughflow for the exemplary embodiment illustrated. The dashed and dotted line 12 shows the throughflow for an example which has a larger angle β than in the case of the line 11. As becomes clear from FIG. 3, the throughflow through the valve 1 from the opening of the valve to a specific stroke H1 is approximately the same for all three examples shown. From the stroke H1, the two examples (line 11 and line 12) have in each case, with a widening through orifice 4, a significantly higher throughflow for the same valve stroke, since the breakaways 7 in the region of the first conical region 6 are markedly reduced.

Admittedly, according to the invention, on the inflow side flow resistance is increased at this point due to the reduced diameter D1. However, this is overcompensated by the surprisingly high positive effect of lower breakaway 7 at the valve seat region. However, if the stroke of the closing element 3 becomes too great, the negative effect of the reduced diameter D1 of the through orifice comes to bear again, so that the throughflow for a cylindrical through orifice becomes greater again (cf. FIG. 3).

1. A valve for controlling fluids, comprising:
a valve element including a through orifice and a valve seat, the valve seat being defined on a first conical region of the valve element; and
a closing element configured to release and close the through orifice at the valve seat,
wherein the through orifice defines a shape that widens in a flow direction.

2. The valve as claimed in claim 1, wherein the through orifice widens conically in the flow direction.

3. The valve as claimed in claim 2, wherein the conically widening through orifice defines an angle of approximately 7.5° with respect to a parallel of a mid-axis of the valve.

4. The valve as claimed in claim 1, wherein the first conical region of the valve element defines an angle of approximately 45° with respect to a parallel of a mid-axis of the valve.

5. The valve as claimed in claim 1, wherein a ratio of a minimum diameter of the through orifice to a maximum diameter of the through orifice is approximately 0.78.

6. The valve as claimed in claim 1, wherein the closing element includes a hemispherical shaped region defining a spherical surface configured to contact the valve.

7. The valve as claimed in claim 1, wherein the valve element includes a second conical region on an inflow side of the valve element, directly adjacent to the through orifice.

8. The valve as claimed in claim 5, wherein a ratio of a maximum stroke of the closing element to the maximum diameter of the through orifice is approximately 0.21.

9. A braking device for a vehicle, comprising:
a valve having: (i) a valve element including a through orifice and a valve seat, the valve seat being defined on a first conical region of the valve element; and (ii) a closing element configured to release and close the through orifice at the valve seat,
wherein the through orifice defines a shape that widens in a flow direction.
